(19) United States
(12) Patent Application Publication
(10) Pub. No.: US 2007/0217189 A1
(43) Pub. Date: Sep. 20, 2007

(54) Illumination Device

(76) Inventor: Morton Graham, Lancashire (GB)

Correspondence Address: Andrus, Sceales, Starke & Sawall, 100 East Wisconsin Avenue, Suite 1100, Milwaukee, WI, 53202-4178, US

(21) Appl. No.: 10/582,889

(22) PCT Filed: Dec. 7, 2004
(86) PCT No.: PCT/GB04/05111

§ 371 Date: Mar. 6, 2007

(30) Foreign Application Priority Data
Dec. 17, 2003 (GB) 0329205.9

(51) Int. Cl. F21S 4/00

(52) U.S. Cl. 362/217

(57) ABSTRACT

An illumination device comprising an elongate rod (10) or strip of translucent material located within a tube (11) to define a gas space (12) therebetween, the rod having a disrupted surface by way of undulation (13) or striation (17), and a light source located at one or both ends of the device to cause light travelling along the rod to exit traversely to its axis. Primary diffusion occurs within the rod by total internal reflection. Secondary diffusion occurs within the gas space, and a substantially uniform light output is generated by the surrounding tube. For longer lengths of rod the striation may be increased within a central region (21, 22) thus to ensure uniformity of light output throughout the length. If required, a beam of light may be generated by providing a reflector (15, 16) within the gas space (12).

THIS INVENTION concerns illumination devices which may be used for highlighting an object such as a building for aesthetic or advertising purposes or for providing illuminated signs. Conventional products for these purposes such as neon or fluorescent lighting require considerable electrical power in operation and in the case of neon lighting a high voltage is required often in the region of several Kilovolts of electricity which has implications both for safety and economy. Furthermore, such products tend to be inefficient in the distribution of light resulting in highlights and dim spots giving an aesthetically unattractive appearance.

An object of the present invention is to provide an illumination device providing substantially uniform light output with minimal power consumption.

According to the present invention there is provided an illumination device comprising a first elongate translucent member, an LED light source located at least at one end or edge of the member to pass light into and along the member, a second translucent member arranged in superimposed relationship with the first translucent member thus to define a gas space therebetween; characterised by a surface formation on the first translucent member causing it, in use, to function as a leaky wave guide allowing light to escape into the gas space for secondary diffusion therein, the second translucent member thus being adapted to pass the secondarily diffused light externally thereof.

The first translucent member may be a rod, and the second translucent member a tube surrounding the rod and defining the gas space therebetween.

The rod may have an undulating surface.

The rod may be of circular cross-section.

The rod may be of elliptical cross-section.

The LED light source may comprise separate light sources disposed at opposite ends respectively of the rod.

A reflector may be disposed on a part of the surface of the first translucent member.

A reflector may be disposed on a part of the surface of the second translucent member facing the first translucent member.

The first translucent member may be of an acrylic or polycarbonate material.

The second translucent member may be of an acrylic or polycarbonate material.

The surface formation may be at least one region of striation on the surface of the first translucent member.

In a central region between the ends of the first translucent member, the striation may be of increased magnitude.

Support means may be provided in the gas space to maintain a predetermined spatial relationship between the first and second translucent members.

Embodiments of the invention will now be described, by way of example only, with reference to the accompanying schematic drawings, in which:

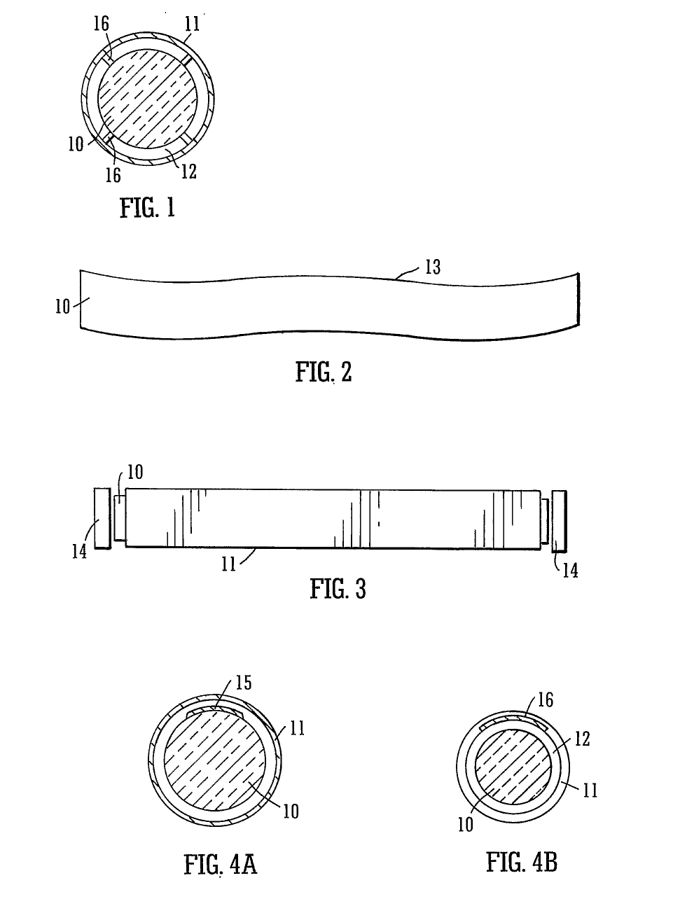

FIG. 1 is a transverse cross-sectional view of an illumination device made in accordance with the invention;

FIG. 2 is a side elevation of a part of the illumination device of FIG. 1, according to a first embodiment;

FIG. 3 is a schematic side elevation of the device of FIG. 1;

FIGS. 4a and 4b are views similar to FIG. 1 illustrating an additional but optional feature.

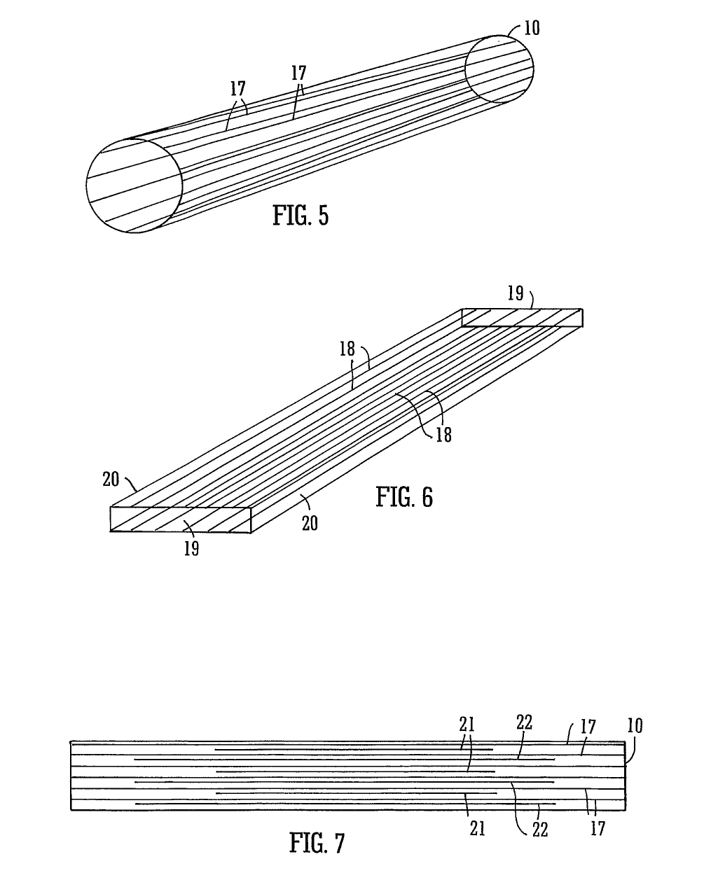

FIG. 5 is a perspective view of a part of the illumination device of FIG. 1, according to a second embodiment.

FIG. 6 is a perspective view of a part of the illumination device of FIG. 1, according to a third embodiment; and

FIG. 7 is a side elevation of a part of the illumination device modified according to a fourth embodiment.

It is known that if light is transmitted into a translucent rod, for example of an acrylic or polycarbonate material, having substantially total internal reflection, the light is primarily diffused and transmitted down the length of the rod but is invisible when viewed externally. The light will obey the law of refraction thus to be directed from plane of the end face at an angle of 48.3°, or 41.7° from the longitudinal axis of the rod.

The light will then obey the rule of total internal reflection so that the photons will continue down the rod being reflected back into the rod at the same angle. Any imperfections in the surface of the rod will allow photons of light to escape but at a very shallow angle with respect to the surface of the rod. If the imperfection is in the form of a scratch then the light will tend to be transmitted almost perpendicular to the surface of the rod.

The illumination device to be described utilises a rod of such a material but wherein the surface imperfection is predetermined such as to permit light to escape from the surface of the rod to a controlled degree as will be described.

Referring now to the drawings, in a first embodiment the illumination device comprises an acrylic or polycarbonate rod 10 which is transparent and has a wavy or undulating surface as shown, in exaggerated form, in FIG. 2. Thus, when light is injected into the end of the rod as will be described, the rod behaves as a leaky wave guide allowing light to escape from its surface at a very shallow angle.

The rod is of circular or elliptical cross-section and is concentrically disposed within an outer translucent, but not transparent, tubular cover 11 which is of sufficiently larger diameter than the rod 10 to define, between them, a gas space 12. The tube 11 may be of a coloured or opalescent acrylic or polycarbonate material. Typically the diameter of the rod 10 will be about 20 mm; the width of the gas space will be some 2 mm; and the thickness of the tube 11 will be about 2 mm.

The rod 10 is provided with a predetermined undulating surface illustrated in exaggerated form at 13 in FIG. 2. The effect of the undulating surface is to allow light to escape from the rod but at a very shallow angle to the surface since there is no sharp disruption to the surface. Within the gas space 12 the leaked light is secondarily diffused and in effect mixed to a substantially uniform distribution of light within the space. The tube 11 then captures this light and transmits it outwardly transverse to the axis of the device to provide a visually uniform light along the length of the device. This light is then visible from any angle with respect to the outer surface of the tube 11 thus to give the overall impression of the uniformly illuminated rod.

As shown in FIG. 1, the rod 10 is supported within the tube 11 by spaced ribs 16 which may be integrally formed with the tube and maintain a uniform gap between the tube and the rod. Thus, with the rod supported concentrically within the tube, lamp units illustrated at 14 in FIG. 3 are sealingly applied to the ends of the rod and tube respectively, the units 14 enclosing an array of LED's which thus project light into the rod 10.

An illumination device of this kind affords a considerable saving in electrical energy when compared with conventional systems. Typically, neon lighting requires 23 watts of electricity per metre and even an efficient LED system would utilise perhaps 6 watts per metre. The increase in efficiency in distributing the light using the concept of a leaky wave guide within a tube with a gas space between them provides a system which may be operated at around 1 watt per metre with equivalent light output.

Referring now to FIG. 4a, there may be provided a reflective strip 15 passing along the length of the leaky wave guide or rod 10 and in surface contact therewith so as to concentrate the light primarily in one direction whilst still creating uniformly distributed light within an angle generated by the width of the reflective strip 15. This may serve to prevent so-called light pollution by illuminating only the surrounding area required to be illuminated. For example, if an illumination device of this kind is mounted on the wall of a building, the light is seen when approaching the building but does not illuminate the wall itself. By careful selection of the width and position of the reflector 15, the beam of visible light may be directed where specifically required.

FIG. 4b shows an alternative, and perhaps preferable arrangement, where a reflective strip 16 is applied, preferably by co-extrusion, to the internal surface of the tube thus to be flush with such surface and to occupy around one quarter of the internal circumference of the tube.

Referring now to FIG. 5, the rod 10 may be between 300 mm and 2 metres in length. It is produced by extrusion and is annealed thus to have, as far as possible, an uninterrupted surface.

In this embodiment, after extrusion, a plurality of striations 17 are cut in the surface of the rod using a diamond cutter or the like to a depth of between 0.5 and 1 mm and of a similar width. Thus, V-shaped striations are created in the surface of the rod and extend at least substantially throughout its length. Preferably, the striations 17 are evenly distributed around the circumference of the rod and are, for example, some twelve in number.

Photons of light from the lamp units 14 will travel down the rod by total internal reflection and by refraction as referred to previously. Each such photon will continue to travel generally lengthwise of the rod until it coincides or collides with one of the striations 17 whereupon light will exit radially from the rod.

Thus, when viewed laterally, the so-illuminated rod will appear to have a multitude of lines of light appearing along its length spaced about its circumference.

By selecting the relationship between the width or depth of the striations 17, and the remaining uninterrupted surface area of the rod, so the value of light exiting from the rod may be determined. The light output is maximised by a certain predetermined relationship between the striations and the clear areas therebetween.

If the diameter is 10 mm and the striations are 0.5 mm wide, then the twelve striations occupy 6 mm of a circumference of 31.42 mm. If the diameter is 30 m and the striations are 1 mm wide, then the twelve striations occupy 12 mm of a circumference of 94.26 mm.

The light introduced at one or both ends of the rod 10 may be provided by single or multiple LEDs which may produce white or coloured light as required.

The striations 17 are preferably cut using a tool which produces a multi-faceted surface within the V-shaped cuts in order to maximise light output from each of the striations.

With the rod enclosed within the tube 11, the striations become largely or completely invisible as defined lines of light and a substantially uniform illumination is created.

Referring now to FIG. 6, in place of the circular cross-sectioned rod, a plate or strip of transparent acrylic material may similarly be provided with striations 18. In this case, the rectangular end faces 19 of the strip may be illuminated with one or more LEDs, and the longitudinal edges 20 may, if required, be rendered opaque or reflective by strips of reflective material attached thereto.

It will be appreciated, however, that the curved profile of the circular sectioned rod provides a lensing effect, thus to magnify the apparent light issuing from the striations.

If the body is other than of circular or rectangular cross-section then again if one face is curved to provide the lens effect, the light is magnified accordingly.

It is clear that the uninterrupted surface area is expected to be greater than that of the line or lines of striation but the relationship may be determined according to the illumination required.

The striations need not be uniformly spaced apart but may be grouped, for example, in one area of the peripheral surface. For example, the striations may occupy only 180° of the circumference of the rod, or some other proportion thereof.

While the bodies 10 and 12 have been shown to have a straight longitudinal axis, nevertheless, they may instead have a curved longitudinal axis. That is, the body may be bent around curves throughout its length while the light will still travel along the length of the body and will exit only by collision with the striations.

If the length of the body relative to its amount of illumination is optionally selected, there may be no apparent loss of illumination at the mid-point between the two light sources. Typically, the light source will be applied at a power of 1 watt per meter length of the body.

Referring now to FIG. 7, if the rod and tube are 2 m or more in length and if there is any noticeable loss of illumination in a central region of the length of the device, then this may be alleviated by providing additional, shorter striations 21, 22 in the spaces between the striations 17, but occupying only about a half of the length of the tube in the central region thereof, thus concentrating the light output in that region farthest from the light sources. If required, for further increased uniformity, alternative ones 22 of the additional striations may be of a length equivalent to, say, three quarters of the rod length.

In all of the embodiments, the gas space is preferably filled with air thus avoiding the potentially harmful properties of phosphors and the like such as are used in neon and fluorescent tubes. The LED lighting unit 14 may be supplied with low voltage power in the region of 10 volts thus further increasing the safety aspects of the present invention.

Such devices may be used for advertising or for highlighting, by illumination, areas or equipment for safety and to increase visibility from a distance. Another use for the device is for the illumination of rooms or corridors within buildings with low levels of light, typically as may be required for emergency lighting and may be used to provide energy savings where high levels of lighting are not required. However, it may be possible to introduce sufficient light energy into the device for it to serve as general ambient lighting and the illumination of a space.

1. An illumination device comprising a first elongate translucent member, an LED light source located at least at one end or edge of the member to pass light into and along the member, a second translucent member arranged in superimposed relationship with the first translucent member thus to define a gas space therebetween;
characterised by a surface formation on the first translucent member causing it, in use, to function as a leaky wave guide allowing light to escape into the gas space for secondary diffusion therein, the second translucent member thus being adapted to pass the secondarily diffused light externally thereof.

2. An illumination device according to claim 1 wherein the first translucent member is a rod, and the second translucent member is a tube surrounding the rod and defining the gas space therebetween.

3. An illumination device according to claim 1 wherein the first translucent member has an undulating surface.

4. An illumination device according to claim 2 wherein the rod is of circular cross-section.

5. An illumination device according to claim 2 wherein the rod is of elliptical cross-section.

6. An illumination device according to claim 1 wherein the LED light source comprises separate light sources disposed at opposite ends respectively of the first translucent member.

7. An illumination device according to claim 1 including a reflector disposed on a part of the surface of the first translucent member.

8. An illumination device according to claim 1 including a reflector disposed on a part of the surface of the second translucent member, facing the first translucent member.

9. An illumination device according to claim 1 wherein the first translucent member is of an acrylic or polycarbonate material.

10. An illumination device according to claim 1 wherein the second translucent member is of an acrylic or polycarbonate material.

11. An illumination device according to claim 1 wherein the surface formation is at least one region of striation on the surface of the first translucent member.

12. An illumination device according to claim 11 wherein, in a central region between the ends of the first translucent member, the striation is of increased magnitude.

13. An illumination device according to claim 1 including support means provided in the gas space to maintain a predetermined special relationship between the first and second translucent members.

14. An illumination device according to claim 8 wherein the reflector is provided by co-extrusion with the second translucent member thus to lie flush with an internal surface thereof.

15. An illumination device according to claim 8 wherein the reflector occupies about one quarter of the extent of the surface of the second translucent member on which it is disposed.

16. An illumination device according to claim 11 wherein the striation comprises a plurality of striations cut in the surface of the first translucent member to a depth of between 0.5 and 1 mm and of a similar width, the V-shaped striations thus created extend at least substantially throughout the length of the first translucent member and are spaced apart around at least a part of the extent of the surface of the first translucent member.

17. An illumination device according to claim 12 wherein the striation of increased magnitude is provided by additional striations occupying less than the overall length of the first translucent member thus to concentrate light output in a region of the device furthest from the light source.
